(19) United States
(12) Patent Application Publication
(10) Pub. No.: US 2025/0181617 A1
(43) Pub. Date: Jun. 5, 2025

(54) GENERATING RESPONSE TO QUERY WITH TEXT EXTRACT FOR BASIS FROM UNSTRUCTURED DATA USING AI MODELS

(71) Applicant: DocLens, Inc, New York, NY (US)

(72) Inventors: Michael Bruton, Western Springs, IL (US); Arnab Dey, New York, NY (US); Vivan Poddar, Sewickley, PA (US); Amit Kumar Saha, Bangalore (IN)

(21) Appl. No.: 18/964,362

(22) Filed: Nov. 30, 2024

Related U.S. Application Data
(60) Provisional application No. 63/605,420, filed on Dec. 1, 2023.

(51) Int. Cl. G06F 16/3329; G06F 16/353; G06F 21/62

(52) U.S. Cl. CPC G06F 16/33295; G06F 16/353; G06F 21/6254

(57) ABSTRACT

Generating responses to queries with text extracts from unstructured data using AI models includes (i) extracting text from unstructured data sources to create machine-searchable documents, (ii) replacing PII and PHI with entity types and attributes, (iii) determining text extracts that indicate criteria, (iv) using a small-scale ML model to perform text searches and find conceptually associated text strings, (v) generating a custom context for a large language model (LLM), (vi) prompting the LLM to generate a response, (vii) combining the response with an extractive QA model to obtain relevant text extracts as response basis, and (viii) providing system-generated recommendations for next best actions based on responses that produce the most optimal outcomes in historical input documents for manually selected or automatically recommended resolution paths.

### CROSS-REFERENCE TO RELATED APPLICATIONS

This patent application claims priority to pending U.S. provisional patent application No. 63/605,420 filed on Dec. 1, 2023, the complete disclosures of which, in their entirety, are hereby incorporated by reference.

### BACKGROUND

### Technical Field

The embodiments herein generally relate to artificial intelligence, and more particularly, to generating a response to a query with text extract for basis from unstructured data using AI models.

### Description of the Related Art

In the field of document analysis, a substantial task is extracting pertinent information from diverse and unstructured data sources. The unstructured data sources may include mutually signed documents, medical reports, and various other textual materials.

A notable technical problem in this domain revolves around generating relevant answers to user queries on unstructured data sources and may be addressed by utilizing a large language model. However, a major drawback of utilizing a large language model is the absence of a basis for the generated responses. This challenge is increased due to the intricate nature of language and the heterogeneous formats of information across documents.

A significant hurdle in achieving accurate responses lies in the tendency of Large Language Models (LLMs) to produce responses that lack a solid foundation, a phenomenon commonly known as “hallucination”. This problem is further increased when the generated responses are expected to indicate facts identified within the unstructured data. This complexity increases when a collection of extracted facts informs subsequent processes, such as determining appropriate procedural steps or actions that depend on the extracted facts. This poses a substantial obstacle to the development of an accurate and reliable system that utilizes LLMs for responding to user queries.

Further, unstructured data sources typically consist of multiple documents that are accumulated at different stages of their lifecycle. The varied nature of these documents further complicates the task, as information relevant to a user query may be dispersed across various files and evolve over time.

Accordingly, there remains a need to address the aforementioned technical problems by generating response to query with text extract for basis from unstructured data using AI models.

### SUMMARY

In view of the foregoing, embodiments herein provide processor-implemented method for generating a response that indicates a criterion and a text extract from an unstructured data source that provides basis for the response using artificial intelligence models, the method comprising (i) extracting text from the unstructured data source to obtain at least one machine-searchable document, (ii) anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities, (iii) determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion, (iv) performing, using a small-scale machine learning model, a text search in the anonymized machine-searchable document to find text strings that are conceptually associated with the text extracts that indicate the criterion, (v) generating a custom context for a large language model (LLM) using (a) the text extracts that indicate the criterion and (b) selecting a number of text-characters before and after the text strings that are conceptually associated with the text extracts, wherein the number of text-characters is dynamically adjusted based on semantic similarity to the text extracts related to the criterion, (vi) generating a response to a query by prompting the LLM with the custom context, wherein the response is indicative of either a negative answer or a positive answer to the query, and (vii) combining the response with the extractive QA machine learning model to obtain relevant text extracts from the unstructured data source that provide basis for the response.

In some embodiments, a criterion category is evaluated for each text extract and a probability of each criterion category, and combining probabilities for each criterion category associated with each text extract to generate an overall risk level for the at least one machine-searchable document.

In some embodiments, a next action is generated for each criterion category by (i) performing, using the LLM, a classification task on the at least one machine-searchable document and the criterion category to automatically infer (a) a resolution path and (b) a current state within the resolution path, and (ii) automatically selecting the next action from a set of pre-determined actions based on the current state by analyzing known outcomes of historical documents corresponding to similar resolution paths and current states.

In some embodiments, next best actions displayed on a graphical user interface (GUI) for a manually selected resolution path or an automatically recommended choice of resolution path.

In some embodiments, a risk profile is generated for the entity based on the text extracts that indicate the criterion by (i) determining an absolute risk and a relative risk for the text extracts using a knowledge data source and the extractive QA machine learning model, and (ii) assigning ratings to the text extracts based on the absolute risk and the relative risk.

In some embodiments, the extractive QA machine learning model is fine-tuned using at least one of example text extracts, a conceptual relationship graph, a semantic search based on vector embeddings, and keyword-based text searches for identifying relevant text snippets.

In a second aspect, there is provided a system for generating a response that indicates a criterion and a text extract from an unstructured data source that provides basis for the response using artificial intelligence models, comprising a memory that stores a set of instructions, and a processor that is configured to execute the set of instructions for (i) extracting text from the unstructured data source to obtain at least one machine-searchable document, (ii) anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities, (iii) determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion, (iv) performing, using a small-scale machine learning model, a text search in the anonymized machine-searchable document to find text strings that are conceptually associated with the text extracts that indicate the criterion, (v) generating a custom context for a large language model (LLM) using (a) the text extracts that indicate the criterion and (b) selecting a predetermined number of text-characters before and after the text strings that are conceptually associated with the text extracts, (vi) generating a response to a query by prompting the LLM with the custom context, wherein the response is indicative of either a negative answer or a positive answer to the query, and (vii) combining the response with the extractive QA machine learning model to obtain relevant text extracts from the unstructured data source that provide basis for the response.

In some embodiments, a criterion category is evaluated for each text extract and a probability of each criterion category, and combining probabilities for each criterion category associated with each text extract to generate an overall risk level for the at least one machine-searchable document.

In some embodiments, a next action is generated for each criterion category by (i) performing, using the LLM, a classification task on the at least one machine-searchable document and the criterion category to automatically infer (a) a resolution path and (b) a current state within the resolution path, and (ii) automatically selecting the next action from a set of pre-determined actions based on the current state by analyzing known outcomes of historical documents corresponding to similar resolution paths and current states.

In some embodiments, next best actions displayed on a graphical user interface (GUI) for a manually selected resolution path or an automatically recommended choice of resolution path.

In some embodiments, a risk profile is generated for the entity based on the text extracts that indicate the criterion by (i) determining an absolute risk and a relative risk for the text extracts using a knowledge data source and the extractive QA machine learning model, and (ii) assigning ratings to the text extracts based on the absolute risk and the relative risk.

In some embodiments, the extractive QA machine learning model is fine-tuned using at least one of example text extracts, a conceptual relationship graph, a semantic search based on vector embeddings, and keyword-based text searches for identifying relevant text snippets.

In a third aspect, there is provided a non-transitory computer readable storage medium storing a sequence of instructions, which when executed by one or more processors, causes a method of generating a response that indicates a criterion and a text extract from an unstructured data source that provides basis for the response using artificial intelligence models, the method comprising (i) extracting text from the unstructured data source to obtain at least one machine-searchable document, (ii) anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities, (iii) determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion, (iv) performing, using a small-scale machine learning model, a text search in the anonymized machine-searchable document to find text strings that are conceptually associated with the text extracts that indicate the criterion, (v) generating a custom context for a large language model (LLM) using (a) the text extracts that indicate the criterion and (b) selecting a predetermined number of text-characters before and after the text strings that are conceptually associated with the text extracts, (vi) generating a response to a query by prompting the LLM with the custom context, wherein the response is indicative of either a negative answer or a positive answer to the query, and (vii) combining the response with the extractive QA machine learning model to obtain relevant text extracts from the unstructured data source that provide basis for the response.

In some embodiments, a criterion category is evaluated for each text extract and a probability of each criterion category, and combining probabilities for each criterion category associated with each text extract to generate an overall risk level for the at least one machine-searchable document.

In some embodiments, a next action is generated for each criterion category by (i) performing, using the LLM, a classification task on the at least one machine-searchable document and the criterion category to automatically infer (a) a resolution path and (b) a current state within the resolution path, and (ii) automatically selecting the next action from a set of pre-determined actions based on the current state by analyzing known outcomes of historical documents corresponding to similar resolution paths and current states.

In some embodiments, a risk profile is generated for the entity based on the text extracts that indicate the criterion by (i) determining an absolute risk and a relative risk for the text extracts using a knowledge data source and the extractive QA machine learning model, and (ii) assigning ratings to the text extracts based on the absolute risk and the relative risk.

In some embodiments, the extractive QA machine learning model is fine-tuned using at least one of example text extracts, a conceptual relationship graph, a semantic search based on vector embeddings, and keyword-based text searches for identifying relevant text snippets.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system for generating response to query with text extract for basis from unstructured data using AI models according to some embodiments herein;

FIG. 2 illustrates an exploded view of a response and basis generation server of FIG. 1 according to some embodiments herein;

FIGS. 3A-D illustrate screens of a computer program product that incorporates the system of FIG. 1 according to some embodiments herein;

FIGS. 4A-4B are flow diagrams that illustrate a method for generating response to query with text extract for basis from unstructured data using AI models according to some embodiments herein;

FIG. 5 is a representative cloud computing environment for practicing the embodiments herein; and

FIG. 6 is a representative hardware environment for practicing the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the view of the foregoing, there is provided a method of generating response to query with text extract for basis from unstructured data using AI models is fulfilled in the ongoing description by (i) extracting text from the unstructured data source to obtain at least one machine-searchable document, (ii) anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities, (iii) determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion, (iv) performing, using a small-scale machine learning model, a text search in the anonymized machine-searchable document to find text strings that are conceptually associated with the text extracts that indicate the criterion, (v) generating a custom context for a large language model (LLM) using (a) the text extracts that indicate the criterion and (b) selecting a predetermined number of text-characters before and after the text strings that are conceptually associated with the text extracts, (vi) generating a response to a query by prompting the LLM with the custom context, wherein the response is indicative of either a negative answer or a positive answer to the query, and (vii) combining the response with the extractive QA machine learning model to obtain relevant text extracts from the unstructured data source that provide basis for the response.

The term “criterion” refers to a specific condition, requirement, or factor that the system is designed to identify or evaluate within unstructured data sources. The criterion may include, but is not limited to, a risk characteristic.

The term “unstructured data source” refers to any source of information that does not have a predefined format or organization, can include documents, text, audio, or video files.

The term “text extract” refers to specific pieces of information or data found within the unstructured data sources that are relevant to indicate a high or low value of the criterion. Each text extract is associated with entity types and entity attributes.

The term “conceptually associated” refers to a relationship between text strings or text extracts that share semantic relevance, contextual similarity, or linguistic alignment, even if the exact terms differ. This association may include synonyms, semantically related words, and phrases derived through natural language processing models.

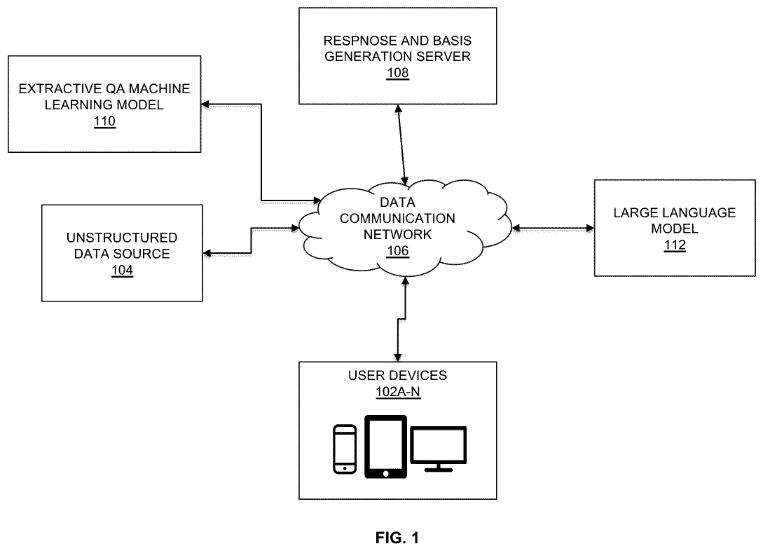

Referring now to the drawings, and more particularly to FIGS. 1 through 6, where similar reference characters denote corresponding features in a consistent manner throughout the figures, there are shown preferred embodiments.

FIG. 1 illustrates a system for generating response to query with text extract for basis from unstructured data using AI models according to some embodiments herein. The system includes one or more user devices 102A-N, an unstructured data source 104, a data communication network 106, a response and basis generation server 108, an extractive QA machine learning model 110 and a large language model 112. The one or more devices 102A-N are communicatively connected to the unstructured data source 104, and also communicatively connected to the response and basis generation server 108 via the data communication network 106. The extractive QA machine learning model 110 and the large language model 112 are communicatively connected to the response and basis generation server 108 via the data communication network 106.

The data communication network 106 may be one or more of a wired network, a wireless network, a combination of the wired network and the wireless network, or the Internet. The one or more devices 102A-N include but are not limited to, a mobile device, a smartphone, a smartwatch, a notebook, a Global Positioning System (GPS) device, a tablet, a desktop computer, a laptop, or any network-enabled device.

The response and basis generation server 108 extracts text from the unstructured data source 104 to obtain one or more documents in a machine-searchable format. The response and basis generation server 108 replaces personally identifiable information (PII) and personal health information (PHI) with entity types using an entity extraction model to obtain an anonymized machine-searchable document having entity types and entity attributes, where the entity extraction model is pre-trained based on entities and their identifiable information.

The response and basis generation server 108 identifies text extracts that indicate the criterion from the machine searchable document with entity types and entity attributes using the extractive question-answer (QA) machine learning model 110. The extractive QA machine learning model 110 may be pre-trained based on specific questions related to the criterion and characteristic language that indicates the criterion.

The response and basis generation server 108 performs, using a small-scale machine learning model, a text search in the anonymized machine-searchable document to find text strings that are conceptually associated with the text extracts that indicate the criterion.

The response and basis generation server 108 generates a custom context for the large language model (LLM) 112 using (a) the text extracts that indicate the criterion and (b) selecting a predetermined number of text-characters before and after the text strings that are conceptually associated with the text extracts. The response and basis generation server 108 generates a response to a query by prompting the LLM with the custom context, wherein the response is indicative of either a negative answer or a positive answer to the query, or a specific entity, and (vii) combining the response with the extractive QA model to obtain relevant text extracts from an unstructured data source that provide basis for the response. The specific entity may include, but is not limited to, a date such as an effective date, a lawyer, a location, etc.

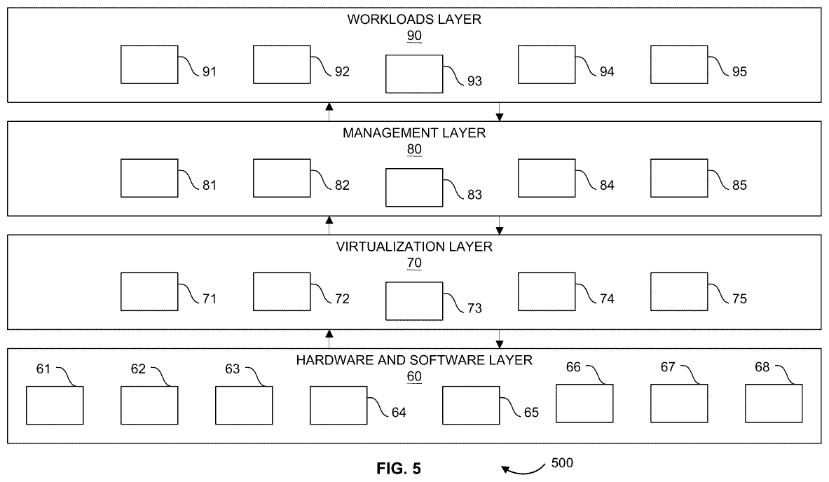

In some embodiments, the response and basis generation server 108 may be implemented as a platform as a service (PaaS) in a cloud computing environment. A representative cloud computing environment is described in FIG. 5 of this specification.

The system 100 not only effectively addresses the limitations highlighted in the background but also introduces several key technical advantages. The system 100 mitigates “hallucination” issues commonly associated with Large Language Models (LLMs). By generating a custom context using both identified text extracts and conceptually associated text strings, the system 100 provides a customized and nuanced input to the LLM, enhancing the ability of the LLM to generate responses that are grounded in authentic information. This approach directly addresses the drawback of unreliable responses stemming from hallucination issues associated with LLMs, thereby improving the accuracy and reliability of the overall system.

Through the combination of the extractive question-answer (QA) model and the small-scale machine learning model for targeted text searches, the system 100 streamlines the risk extraction process. This results in a faster and more efficient identification of text extracts from unstructured data sources that indicate the criterion, enhancing the ability of the system 100 to promptly respond to user queries and deliver risk-related insights accurately.

Further, the system 100 offers a technical advancement by enabling the capability for the analysis of unstructured data for risk extraction. By utilizing both the extractive QA model and custom context generation for the LLM, the system 100 enables interpretation of complex documents and identifying risk contributors. This technical advancement enables the system 100 to comprehensively analyze unstructured data, providing a more nuanced understanding of the associated criterion and contributing factors.

Furthermore, the system 100 improves the functioning of the computer system by incorporating a small-scale machine learning model for targeted text searches. The small-scale machine learning model enables a more focused exploration of the machine-searchable documents and identifies text strings that are conceptually associated with the criterion. The usage of the small-scale machine learning model not only improves the efficiency of information retrieval but also minimizes false positives and false negatives. This results in an effective utilization of computational resources and improved performance in the generation of query responses from the LLM.

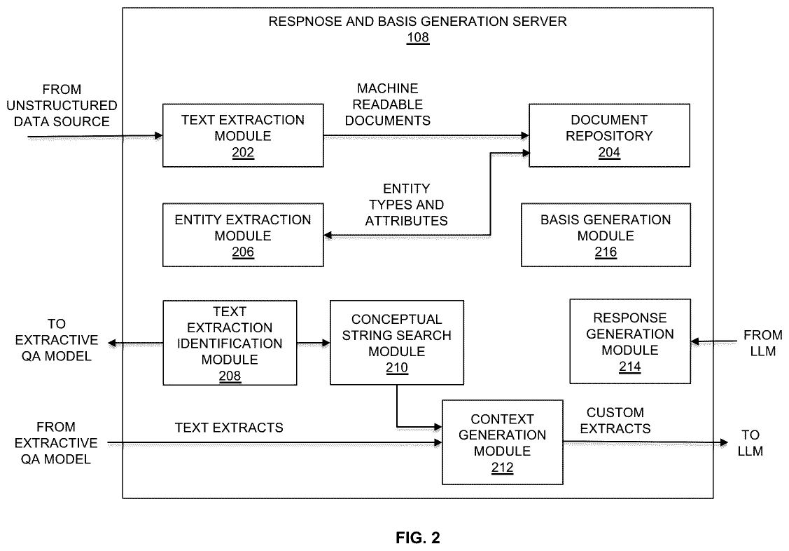

FIG. 2 illustrates an exploded view of the response and basis generation server 108 of FIG. 1 according to some embodiments herein. The response and basis generation server 108 includes a text extraction module 202, a document repository 204, an entity extraction module 206, a text extract identification module 208, a conceptual string search module 210, a context generation module 212, a response generation module 214 and a basis generation module 216.

The text extraction module 202 extracts text from the unstructured data source 104 to obtain one or more documents in a machine-searchable format. The unstructured data source may include a voice mail, an email, a supporting document, an audio or a video.

The entity extraction module 206 replaces personally identifiable information (PII) and personal health information (PHI) with entity types using an entity extraction model to obtain an anonymized machine-searchable document having entity types and entity attributes, where the entity extraction model is pre-trained based on entities and their identifiable information. The entity types may include, but are not limited to, a party, a claimant. The entity attributes may include, but are not limited to, an address, an email, a phone number, a date of birth or a health information. The entity extraction model may or may not be different from the extractive question-answer (QA) machine learning model 110.

The text extract identification module 208 identifies text extracts that indicate the criterion from the machine searchable document with entity types and entity attributes using the extractive question-answer (QA) machine learning model 110. The text extracts may include a word, a sentence or a paragraph. The text extract comprises a location of the text extract in the machine searchable document. The extractive QA machine learning model 110 may be pre-trained based on specific questions related to the criterion and characteristic language that indicates the criterion. The extractive QA machine learning model 110 may be pre-trained on characteristic language or keyword searches, including synonyms and common variants of the characteristic language.

The conceptual string search module 210 performs, using a small-scale machine learning model, a text search in the anonymized machine-searchable document to find text strings that are conceptually associated with the text extracts that indicate the criterion. The conceptual association may extend beyond exact matches and include synonyms, semantically related terms, and contextually similar phrases. In some embodiments, the conceptual string search module 210 may utilize a fuzzy search method to look for alternate usage of the text strings (for example, “diabetes” and “diabetic”) and also identify a negative context when two text strings are conceptually distanced above a threshold.

In some embodiments, the conceptual string search module 210 utilizes a large language model to identify text strings that are conceptually associated with the text extracts. For example, if a text string includes the term “diabetes,” the LLM may suggest related terms such as “diabetic condition,” “blood sugar,” or “chronic illness.” Similarly, a search for “cancer” may also include synonyms such as “malignancy” or “tumor.”

The context generation module 212 generates a custom context for the large language model (LLM) 112 using (a) the text extracts that indicate the criterion and (b) selecting a predetermined number of text-characters before and after the text strings that are conceptually associated with the text extracts. The response generation module 214 generates a response to a query by prompting the LLM with the custom context, wherein the response is indicative of either a negative answer or a positive answer to the query, or a specific entity. The basis generation module 216 combines the response with the extractive QA model to obtain relevant text extracts from an unstructured data source that provide basis for the response.

In some embodiments, a criterion category is evaluated for each text extract and a probability of each criterion category, and combining probabilities for each criterion category associated with each text extract to generate an overall risk level for the at least one machine-searchable document.

In some embodiments, a next action is generated for each criterion category. The next action for each criterion are generated by performing, using the LLM, a classification task on the at least one machine-searchable document and the criterion category to automatically infer (a) a resolution path and (b) a current state within the resolution path, and automatically selecting the next action from a set of pre-determined actions based on the current state by analyzing known outcomes of historical documents corresponding to similar resolution paths and current states. The ability to identify and analyze specific language in the unstructured data sources that contribute to the overall risk level enable the response and basis generation server 108 to inform next best actions based on a thorough risk assessment.

As an example, a resolution path “Prevail” may apply to scenarios aimed at achieving a favorable outcome and may include actions such as ‘Preliminary Motion’, ‘Trial or Hearing’, ‘Summary Judgment’ and ‘Appeal’. Another resolution path ‘Compromise’ may include actions such as ‘Offer Made’, ‘Investigation Ongoing’, ‘Demand Received’, and ‘Mediation’. Another resolution path ‘Monitor Only’ may apply to documents with statuses such as “Pending,” “In-progress,” or “Done” and focuses on observing and tracking developments.

The resolution paths may be automatically inferred using an LLM that performs a classification task on the input documents. The LLM analyzes the content of the documents, evaluates the associated risks, and assigns each document to the most appropriate resolution path based on predefined criteria. For example, a document indicating unresolved legal matters may be classified under the “Prevail” path, while one suggesting potential settlement opportunities may fall under the “Compromise” path.

Once the resolution path is inferred, the system generates next best actions by analyzing historical data corresponding to similar resolution paths, identified risks, and document contexts. A recommendation system evaluates pre-determined actions and selects those that are most likely to lead to favorable outcomes. A “favorable outcome” may refer to a result that aligns with predefined objectives or metrics, such as a litigation result favoring the plaintiff or a scenario where the financial impact, such as the payout amount, is minimized. The system uses historical claim outcomes, payout patterns, and contextual attributes to rank and prioritize actions. For instance, if historical data indicates that mediation has resolved similar cases effectively, the system may recommend ‘mediation’ as the next best action for documents under the ‘Compromise’ resolution path.

In some embodiments, the response and basis generation server 108 may be incorporated in a decision support module, that integrates risk contributors, thereby enhancing decision-making processes and providing users with informed and contextually relevant recommendations for the unstructured data sources.

In some embodiments, the system utilizes a state-based decision process to enhance the capabilities of a large language model (LLM) in a structured decision-making process. The state-based decision process includes identifying a current state within a resolution path and generating contextually appropriate actions or recommendations based on the state and predefined rules or conditions. Thereby, a technical advantage is provided by structuring the decision-making process into discrete, traceable states, that are enabled by analysis of input data and predefined resolution paths performed by the system.

The state-based decision process provides clear, contextual boundaries for the LLM, reducing ambiguity and improving the relevance and accuracy of the outputs of the LLM. Thereby, the state-based decision process improves the ability of the LLM to generate responses based on specific contexts of various technical domains, from anomaly detection systems to task automation workflows. For example, in the context of a computer network anomaly detection system, the state-based decision process may include resolution paths such as “Mitigate”, “Investigate”, and “Monitor”. Within the “Mitigate” resolution path, the system transitions through states like Backup Activation, where a critical network anomaly, such as a failure in a primary server or link, prompts the system to activate backup servers or reroute traffic to redundant network paths to ensure continuity of service. This may be followed by a Traffic Throttling state, where the system dynamically reduces the bandwidth allocated to non-critical services or traffic flows to mitigate strain on the affected network components while preserving essential operations. Finally, the system may enter a Configuration Update state, where a network configuration patch, such as updated routing policies or firewall rules, is deployed to resolve the anomaly and restore normal functionality according to predefined protocols. In some embodiments, a risk profile is generated for the entity based on the text extracts that indicate the criterion by (a) determining an absolute risk and a relative risk for the text extracts using a knowledge data source, and (b) assigning ratings to the text extracts based on the absolute risk and the relative risk.

In some embodiments, the extractive QA machine learning model is fine-tuned using example text extracts.

In some embodiments, it is determined, using a custom machine learning model, if an identified text extract is favorable or unfavorable to a user by analyzing the context of the text extract and when available, comparing the identified text extract to a preferred text extract.

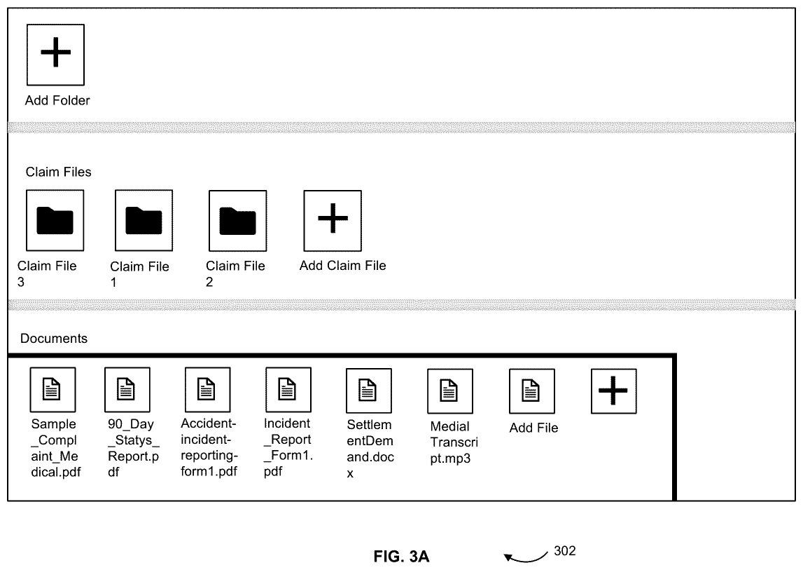

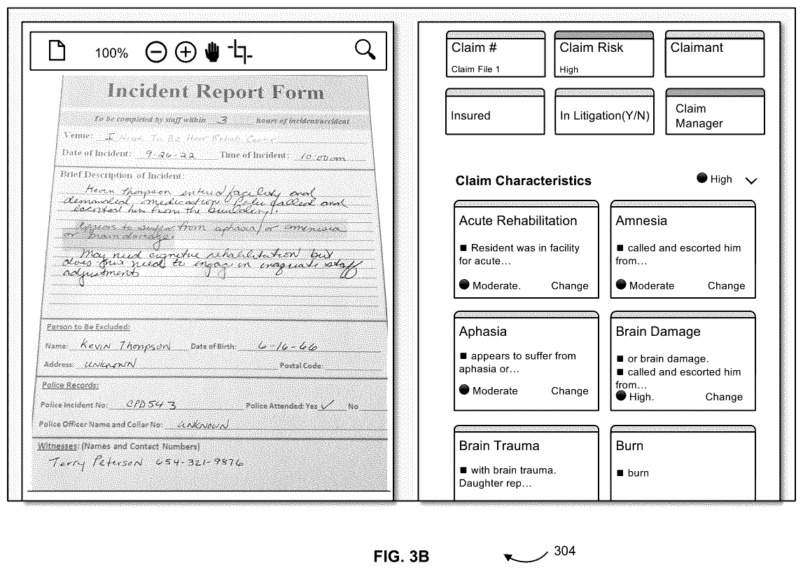

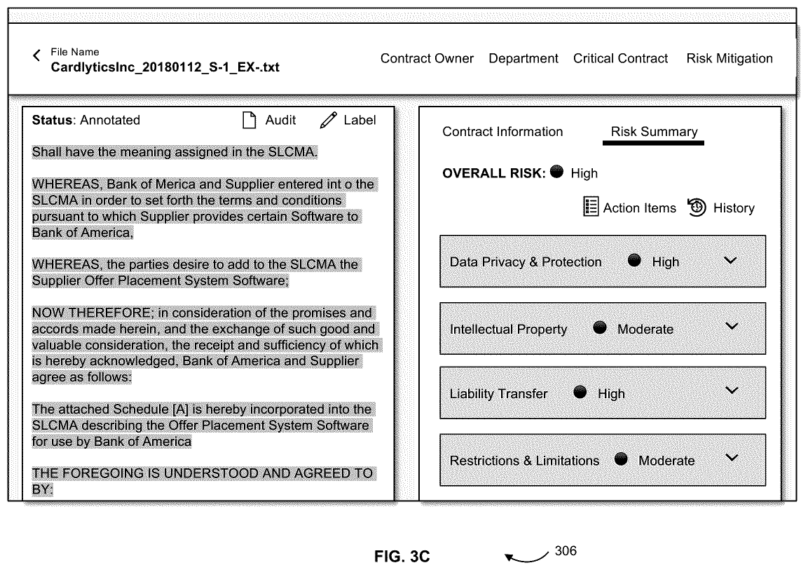

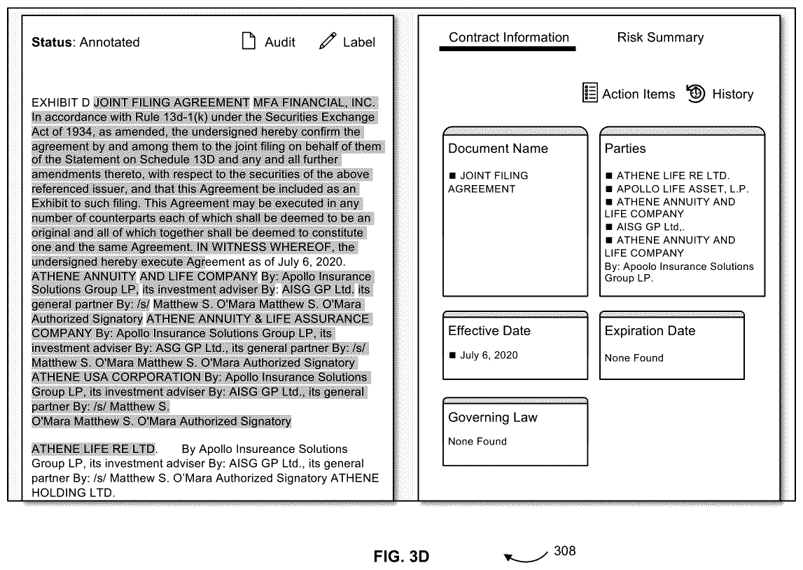

FIGS. 3A-D illustrate screens of a computer program product that incorporates the system of FIG. 1 according to some embodiments herein.

FIG. 3A illustrates a dynamic interface 302 that enables incorporation of unstructured data sources of various formats, including “PDF”, “DOCX”, “MP3”, etc.

FIG. 3B illustrates a dynamic interface 304 presenting a side-by-side view of an original document and entity attributes from the original document. The representation enables understanding of entity attributes that inform the criterion of an entity.

FIG. 3C illustrates a dynamic interface 306 presenting a side-by-side view of an original document and a contextual criterion grouping extracted from the original document. The contextual criterion grouping enables understanding of levels of criterion in the original document.

FIG. 3D illustrates a dynamic interface 308 presenting a side-by-side view of an original document and a grouping of entities extracted from the original document entities and their identifiable information.

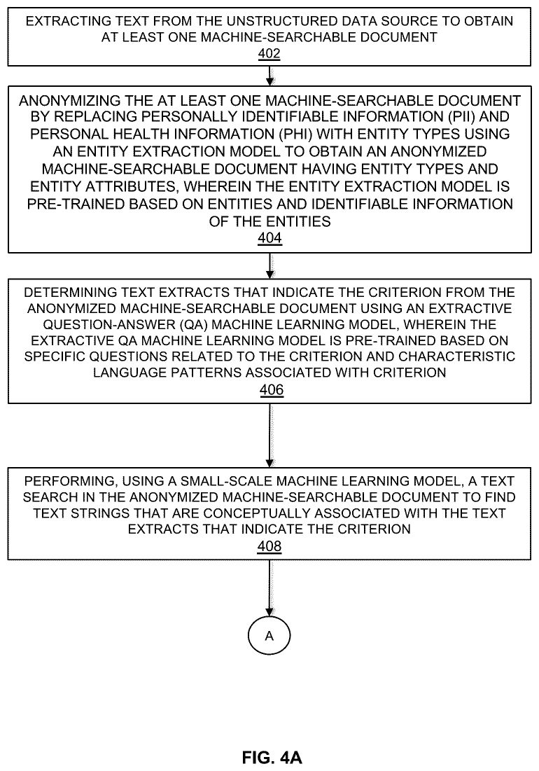

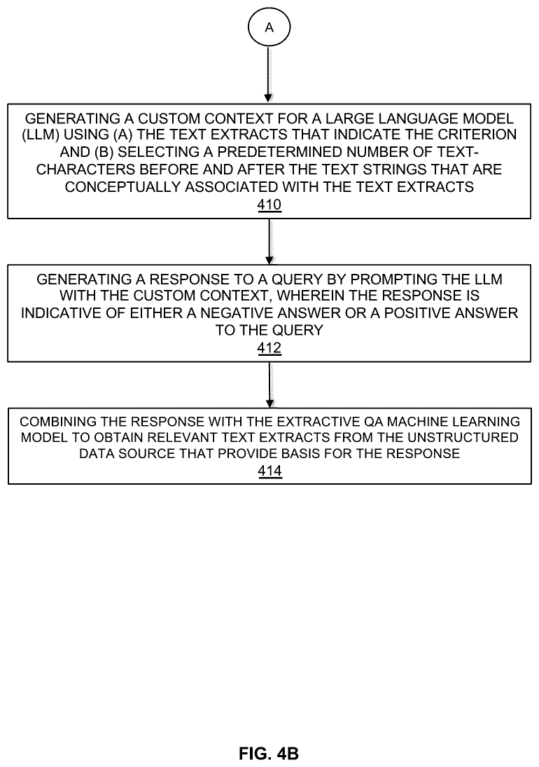

FIGS. 4A-4B are flow diagrams that illustrate a method for generating response to query with text extract for basis from unstructured data using AI models according to some embodiments herein. At step 402, the method includes extracting text from the unstructured data source to obtain at least one machine-searchable document. At step 404, the method includes anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and their identifiable information. At step 406, the method includes determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion. At step 408, the method includes performing, using a small-scale machine learning model, a text search in the anonymized machine-searchable document to find text strings that are conceptually associated with the text extracts that indicate the criterion. At step 410, the method includes generating a custom context for a large language model (LLM) using (a) the text extracts that indicate the criterion and (b) selecting a predetermined number of text-characters before and after the text strings that are conceptually associated with the text extracts. At step 412, the method includes generating a response to a query by prompting the LLM with the custom context, wherein the response is indicative of either a negative answer or a positive answer to the query, or a specific entity. At step 414, the method includes combining the response with the extractive QA model to obtain relevant text extracts from an unstructured data source that provide basis for the response.

The method not only effectively addresses the limitations highlighted in the background but also introduces several key technical advantages. The system 100 mitigates “hallucination” issues commonly associated with Large Language Models (LLMs). By generating a custom context using both identified text extracts and conceptually associated text strings, the method provides a customized and nuanced input to the LLM, enhancing the ability of the LLM to generate responses that are grounded in authentic information. This approach directly addresses the drawback of unreliable responses stemming from hallucination issues associated with LLMs, thereby improving the accuracy and reliability of the overall system.

Through the combination of the extractive question-answer (QA) model and the small-scale machine learning model for targeted text searches, the method streamlines the risk extraction process. This results in a faster and more efficient identification of text extracts from unstructured data sources that indicate the criterion, enhancing the ability of the method to promptly respond to user queries and deliver risk-related insights accurately.

Further, the method offers a technical advancement by enabling the capability for the analysis of unstructured data for risk extraction. By utilizing both the extractive QA model and custom context generation for the LLM, the method enables interpretation of complex documents and identifying risk contributors. This technical advancement enables the method to comprehensively analyze unstructured data, providing a more nuanced understanding of the associated criterion and contributing factors.

Furthermore, the method improves the functioning of the computer system by incorporating a small-scale machine learning model for targeted text searches. The small-scale machine learning model enables a more focused exploration of the machine-searchable documents and identifies text strings that are conceptually associated with the criterion. The usage of the small-scale machine learning model not only improves the efficiency of information retrieval but also minimizes false positives and false negatives. This results in an effective utilization of computational resources and improved performance in the generation of query responses from the LLM.

In some embodiments, a criterion category is evaluated for each text extract and a probability of each criterion category, and combining probabilities for each criterion category associated with each text extract to generate an overall risk level for the at least one machine-searchable document.

In some embodiments, a next action is generated for each criterion category. The ability to identify and analyze specific language in the unstructured data sources that contribute to the overall risk level enables the response and basis generation server 108 to inform next best actions based on a thorough risk assessment.

In some embodiments, the response and basis generation server 108 may be incorporated in a decision support module, that integrates risk contributors, thereby enhancing decision-making processes and providing users with informed and contextually relevant recommendations for the unstructured data sources.

In some embodiments, a risk profile is generated for the entity based on the text extracts that indicate the criterion by (a) determining an absolute risk and a relative risk for the text extracts using a knowledge data source, and (b) assigning ratings to the text extracts based on the absolute risk and the relative risk.

In some embodiments, the extractive QA machine learning model is fine-tuned using example text extracts.

In some embodiments, it is determined, using a custom machine learning model, if an identified text extract is favorable or unfavorable to a user by analyzing the context of the text extract and when available, comparing the identified text extract to a preferred text extract.

The various systems and corresponding components described herein and/or illustrated in the figures may be embodied or utilized in different cloud computing environments, including a distributed data processing environment or distributed computing environments. It is to be understood that although a detailed description of a cloud computing environment is provided, implementation of the teachings provided herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service. A cloud computing environment is service oriented with a focus on statelessness, low coupling, modularity, and semantic interoperability. Essentially, cloud computing is an infrastructure that includes a network of interconnected nodes. As an example, a cloud computing environment may include one or more cloud computing nodes with which local computing devices used by cloud consumers, such as, for example, cellular telephone, desktop computer, laptop computer, and/or automobile computer system may communicate. The one or more cloud computing nodes may communicate with one another and may be grouped physically or virtually, in one or more networks, such as private, community, public, or hybrid clouds as described hereinabove, or a combination thereof. This allows the cloud computing environment to offer infrastructure, platforms and/or software as services for which a cloud consumer does not need to maintain resources on a local computing device. It is understood that one or more cloud computing nodes and the cloud computing environment can communicate with any type of computerized device over any type of network and/or network addressable connection, e.g., using a web browser.

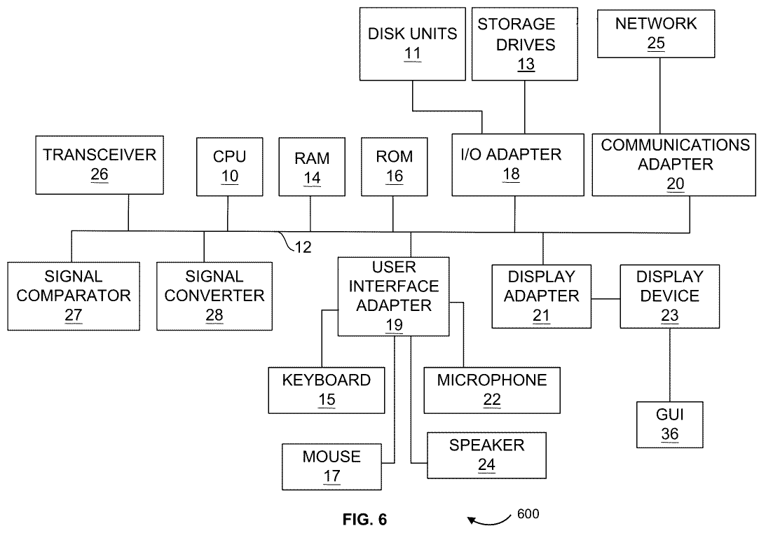

Referring now to FIG. 5, a representative cloud computing environment 500 comprising a set of functional abstraction layers are shown. It should be understood in advance that the components, layers, and functions shown in FIG. 6 are intended to be illustrative only and embodiments of the invention are not limited thereto. As depicted, the following layers and corresponding functions are provided. A hardware and software layer 60 includes hardware and software components. Examples of hardware components include mainframes 61, RISC (Reduced Instruction Set Computer) architecture-based servers 62, servers 63, blade servers 64, storage devices 65, and networks and networking components 66. In some embodiments, software components include network application server software 67 and database software 68. A virtualization layer 70 provides an abstraction layer from which the following examples of virtual entities may be provided virtual servers 71, virtual storage 72, virtual networks 73, including virtual private networks, virtual applications and operating systems 74, and virtual clients 75.

In one example, management layer 80 may provide the functions described below. Resource provisioning 81 provides dynamic procurement of computing resources and other resources that are utilized to perform tasks within the cloud computing environment 500. Metering and pricing 82 provide cost tracking as resources are utilized within the cloud computing environment 500, and billing or invoicing for consumption of these resources. In one example, these resources may include application software licenses. Security provides identity verification for cloud consumers and tasks, as well as protection for data and other resources. User portal 83 provides access to the cloud computing environment 500 for consumers and system administrators. Service level management 84 provides cloud computing resource allocation and management such that required service levels are met.

Workloads layer 90 provides examples of functionality for which the cloud computing environment 500 may be utilized. Examples of workloads and functions which may be provided from this layer include mapping and navigation 91, software development and lifecycle management 92, virtual classroom education delivery 93, data analytics processing 94, transaction processing 95, and microservice recipe creation 96.

The embodiments herein can take the form of a computer program product accessible from a computer-usable or computer-readable medium providing program code for use by or in connection with a computer or any instruction execution system. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM) and, a rigid magnetic disk.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

A representative hardware environment for practicing the embodiments herein is depicted in FIG. 6, with reference to FIGS. 1 through 5. This schematic drawing illustrates a hardware configuration of a software development device/computer system 600 in accordance with the embodiments herein. The system includes at least one processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system 600 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network, and a display adapter 21 connects the bus 12 to a display device 23, which provides a graphical entity interface (GUI) 36 of the output data in accordance with the embodiments herein, or which may be embodied as an output device such as a monitor, printer, or transmitter, for example. Further, a transceiver 26, a signal comparator 27, and a signal converter 28 may be connected with the bus 12 for processing, transmission, receipt, comparison, and conversion of electric signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A processor-implemented method for generating a response that indicates a criterion and a text extract from an unstructured data source that provides basis for the response using artificial intelligence models, the method comprising:
extracting text from the unstructured data source to obtain at least one machine-searchable document;
anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities;
determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion;
performing, using a small-scale machine learning model, a text search in the anonymized machine-searchable document to find text strings that are conceptually associated with the text extracts that indicate the criterion;
generating a custom context for a large language model (LLM) using (a) the text extracts that indicate the criterion and (b) selecting a predetermined number of text-characters before and after the text strings that are conceptually associated with the text extracts;
generating a response to a query by prompting the LLM with the custom context, wherein the response is indicative of either a negative answer or a positive answer to the query; and
combining the response with the extractive QA machine learning model to obtain relevant text extracts from the unstructured data source that provide basis for the response.

2. The processor-implemented method of claim 1, further comprising evaluating a criterion category for each text extract and a probability of each criterion category, and combining probabilities for each criterion category associated with each text extract to generate an overall risk level for the at least one machine-searchable document.

3. The processor-implemented method of claim 2, further comprising generating a next action for each criterion category by:
performing, using the LLM, a classification task on the at least one machine-searchable document and the criterion category to automatically infer (a) a resolution path and (b) a current state within the resolution path; and
automatically selecting the next action from a set of pre-determined actions based on the current state by analyzing known outcomes of historical documents corresponding to similar resolution paths and current states.

4. The processor-implemented method of claim 3, further comprising displaying, on a graphical user interface (GUI), next best actions for a manually selected resolution path or an automatically recommended choice of resolution path.

5. The processor-implemented method of claim 2, further comprising generating a risk profile for the entity based on the text extracts that indicate the criterion by:
determining an absolute risk and a relative risk for the text extracts using a knowledge data source and the extractive QA machine learning model; and
assigning ratings to the text extracts based on the absolute risk and the relative risk.

6. The processor-implemented method of claim 1, further comprising fine-tuning the extractive QA machine learning model using at least one of example text extracts, a conceptual relationship graph, a semantic search based on vector embeddings, and keyword-based text searches for identifying relevant text snippets.

7. The processor-implemented method of claim 1, further comprising determining, using a custom machine learning model, if an identified text extract is favorable or unfavorable to a user by analyzing the context of the text extract and when available, comparing the identified text extract to a preferred text extract.

8. A system for generating a response that indicates a criterion and a text extract from an unstructured data source that provides basis for the response using artificial intelligence models, comprising:
a memory that stores a set of instructions; and
a processor that is configured to execute the set of instructions for:
extracting text from the unstructured data source to obtain at least one machine-searchable document;
anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities;
determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion;
performing, using a small-scale machine learning model, a text search in the anonymized machine-searchable document to find text strings that are conceptually associated with the text extracts that indicate the criterion;
generating a custom context for a large language model (LLM) using (a) the text extracts that indicate the criterion and (b) selecting a predetermined number of text-characters before and after the text strings that are conceptually associated with the text extracts;
generating a response to a query by prompting the LLM with the custom context, wherein the response is indicative of either a negative answer or a positive answer to the query; and
combining the response with the extractive QA machine learning model to obtain relevant text extracts from the unstructured data source that provide basis for the response.

9. The system of claim 8, further comprising evaluating a criterion category for each text extract and a probability of each criterion category, and combining probabilities for each criterion category associated with each text extract to generate an overall risk level for the at least one machine-searchable document.

10. The system of claim 9, further comprising generating a next action for each criterion category by:
performing, using the LLM, a classification task on the at least one machine-searchable document and the criterion category to automatically infer (a) a resolution path and (b) a current state within the resolution path; and
automatically selecting the next action from a set of pre-determined actions based on the current state by analyzing known outcomes of historical documents corresponding to similar resolution paths and current states.

11. The system of claim 10, further comprising displaying, on a graphical user interface (GUI), next best actions for a manually selected resolution path or an automatically recommended choice of resolution path.

12. The system of claim 9, further comprising generating a risk profile for the entity based on the text extracts that indicate the criterion by:
determining an absolute risk and a relative risk for the text extracts using a knowledge data source and the extractive QA machine learning model; and
assigning ratings to the text extracts based on the absolute risk and the relative risk.

13. The system of claim 8, further comprising fine-tuning the extractive QA machine learning model using at least one of example text extracts, a conceptual relationship graph, a semantic search based on vector embeddings, and keyword-based text searches for identifying relevant text snippets.

14. The system of claim 8, further comprising determining, using a custom machine learning model, if an identified text extract is favorable or unfavorable to a user by analyzing the context of the text extract and when available, comparing the identified text extract to a preferred text extract.

15. A non-transitory computer readable storage medium storing a sequence of instructions, which when executed by one or more processors, causes a method of generating a response that indicates a criterion and a text extract from an unstructured data source that provides basis for the response using artificial intelligence models, the method comprising:
extracting text from the unstructured data source to obtain at least one machine-searchable document;
anonymizing the at least one machine-searchable document by replacing personally identifiable information (PII) and personal health information (PHI) with entity types using an entity extraction model to obtain an anonymized machine-searchable document having entity types and entity attributes, wherein the entity extraction model is pre-trained based on entities and identifiable information of the entities;
determining text extracts that indicate the criterion from the anonymized machine-searchable document using an extractive question-answer (QA) machine learning model, wherein the extractive QA machine learning model is pre-trained based on specific questions related to the criterion and characteristic language patterns associated with criterion;
performing, using a small-scale machine learning model, a text search in the anonymized machine-searchable document to find text strings that are conceptually associated with the text extracts that indicate the criterion;
generating a custom context for a large language model (LLM) using (a) the text extracts that indicate the criterion and (b) selecting a predetermined number of text-characters before and after the text strings that are conceptually associated with the text extracts;
generating a response to a query by prompting the LLM with the custom context, wherein the response is indicative of indicative of either a negative answer or a positive answer to the query; and
combining the response with the extractive QA machine learning model to obtain relevant text extracts from the unstructured data source that provide basis for the response.

16. The non-transitory computer readable storage medium storing a sequence of instructions of claim 15, further comprising evaluating a criterion category for each text extract and a probability of each criterion category, and combining probabilities for each criterion category associated with each text extract to generate an overall risk level for the at least one machine-searchable document.

17. The non-transitory computer readable storage medium storing a sequence of instructions of claim 16, further comprising generating a next action for each criterion category by:
performing, using the LLM, a classification task on the at least one machine-searchable document and the criterion category to automatically infer (a) a resolution path and (b) a current state within the resolution path; and
automatically selecting the next action from a set of pre-determined actions based on the current state by analyzing known outcomes of historical documents corresponding to similar resolution paths and current states.

18. The non-transitory computer readable storage medium storing a sequence of instructions of claim 16, further comprising generating a risk profile for the entity based on the text extracts that indicate the criterion by:
determining an absolute risk and a relative risk for the text extracts using a knowledge data source and the extractive QA machine learning model; and
assigning ratings to the text extracts based on the absolute risk and the relative risk.

19. The non-transitory computer readable storage medium storing a sequence of instructions of claim 15, further comprising fine-tuning the extractive QA machine learning model using at least one of example text extracts, a conceptual relationship graph, a semantic search based on vector embeddings, and keyword-based text searches for identifying relevant text snippets.

20. The non-transitory computer readable storage medium storing a sequence of instructions of claim 15, further comprising determining, using a custom machine learning model, if an identified text extract is favorable or unfavorable to a user by analyzing the context of the text extract and when available, comparing the identified text extract to a preferred text extract.
